(19) United States
(12) Patent Application Publication
(10) Pub. No.: US 2021/0034343 A1
(43) Pub. Date: Feb. 4, 2021

(54) Systems, Methods and Storage Media for Producing Verifiable Protected Code

(71) Applicant: Irdeto Canada Corporation, Ottawa (CA)

(72) Inventors: Bahman SISTANY, Ottawa (CA); Harold JOHNSON, Ottawa (CA)

(21) Appl. No.: 16/527,192

(22) Filed: Jul. 31, 2019

(51) Int. Cl. G06F 8/41; G06F 8/73; G06F 8/77

(52) U.S. Cl. CPC G06F 8/436; G06F 8/443; G06F 8/77; G06F 8/73

(57) ABSTRACT

Systems, methods, and storage media for producing protected code in which functionality of the protected code can be verified are disclosed. Exemplary implementations may: receive computer source code that, when compiled and executed, produces functionality in accordance with code specifications, the code including executable code and annotations; apply transformations to at least one portion of the computer source code to produce transformed code having at least one transformed portion of executable code and annotations; store the transformed source code; create an additional annotation which includes verification properties and/or verification conditions that must hold true for the transformed code if the transformed code conforms to the code specifications, the annotation also including at least one hint; and store the annotation in correspondence to the relevant at least one transformed portion of the transformed source code to produce protected code.

### FIELD OF THE DISCLOSURE

The present disclosure relates to systems, methods, and storage media for producing protected code in which functionality of the protected code can be verified.

### BACKGROUND

It is of course important that computing environments, including computer executable software, function “correctly”, i.e., that the environment will behave according to explicit and/or implicit specifications that describe the desired functionality of the computing environment. Typically, extensive testing is done to increase the confidence in correct functionality of a piece of software. However, known testing is often based on inductive reasoning, i.e. where an increasing number of successful tests is taken to infer an increase in the likelihood of correctness. Therefore, positive test results are not a complete proof of correctness. In systems where more assurance of correctness is required various types of deductive reasoning can be used. For example, formal verification methods based on theoretical foundations rooted in logic can be used. It is important to note that formal verification transfers the problem of confidence in software correctness to the problem of confidence in specification correctness. However, while formal verification is not a “silver bullet”, specifications are often smaller and less complex to express, and thus formal verification can successfully increase the chances of achieving software correctness.

Formal verification methods typically employ a specification language based on familiar “assertions.” For example, Boolean assertions express properties related to the behavior of the system which should be TRUE at a particular point during execution of the code for the system. The underlying system must then be shown to conform to such properties (i.e., such property expressions must be shown to be TRUE at that point for every execution of the system). A property is typically expressed in some variation of first order logic and the verification system will deductively try to prove the property correct or indicate otherwise. This is a rather elaborate process where these assertion statements are used to generate logic formulas that are then fed into a Satisfiable Modulo Theories (SMT) solver in a known manner.

It is known to increase the security of computer code by applying transformations, such as obfuscations, to portions of the code. Such transformations are intended to make it difficult for an attacker to follow the code logic and flow and thus render the transformed code more resistant to attack. It is axiomatic that the transformations must at least substantially preserve the function of the original code (such preservation is known as “semantic equivalence”). When code transformations invalidate, or seem to invalidate, or even make difficult to show, that the properties of the original code are preserved (i.e. that the code is correct with respect to certain specified behavior), it can be difficult, if not impossible, to demonstrate that the transformed code is semantically equivalent to the original code. The more complex the transformations, the larger the computing resources required to show that existing properties are maintained. In many cases, it is not pragmatic to demonstrate semantic equivalence in transformed code because of the required resources and resulting uncertainties.

Software obfuscation tools have largely ignored this problem because, e.g., software they have been designed to protect has not generally been deployed in safety-critical systems (such as medical equipment or autonomous vehicle control software) or systems in which conformance to specified functionality is critical (such as software controlling satellites in orbit, or software implementing avionic functionality). However, some IoT (Internet of Things) applications, such as control-systems and control-related systems for autonomous or driver-assistance systems in ground transport, operate in an environment very well known to be exposed to potential hackers, malware, and other hazards previously associated primarily with personal computing. For example, many such systems are implemented in a “whitebox: environment, i.e., an environment where potential attackers are assumed to have full access to the code.

Therefore, there is a growing need for software protection which can be deployed in contexts involving critical functionality and safety considerations, and where hardware security cannot be assumed. Of course, this should be accomplished without placing at risk the very functionality of the software which needs to be protected. Moreover, software implementing safety-critical or functionality-critical operations may itself already contain annotations, such as assertions, which form part of the software's specification, so that the software (in its original form prior to applying protective transformations) can be verified using commercial software validation tools. Thus, the problem of validating the applied protections is exacerbated by the problem of maintaining a valid connection between the input software's code and the input software's verification assertions, even after the application of transformations to the code.

To achieve the highest levels of assurance that transformations to computer software code have substantially maintained correctness of the code, it is necessary to prove that the original version of the code and the transformed version of the code (and the transformed version of the annotations which were present in the original code) are semantically equivalent. Proving semantic equivalency is possible in certain cases but is extremely difficult in most practical situations. It is known to use formally verified compilers such as CompCert™. However, the problem with verifying a compiler is scale. Such verification of semantic equivalence between C and generated assembly can take several “man years” to complete. Further, while total equivalency to the two versions of a program certainly implies the correctness of certain properties of interest, it does not directly show validity of these properties.

### SUMMARY

One aspect of the present disclosure relates to a system configured for producing protected code in which functionality of the protected code can be verified. The system may include one or more hardware processors configured by machine-readable instructions. The processor(s) may be configured to receive original computer source code that, when compiled and executed, produces functionality in accordance with code specifications. The processor(s) may be configured to apply transformations to at least one portion of the computer source code to produce transformed source code having at least one transformed portion, and, where verification annotations are present in the original code, to transform those annotations also, so that verification of the transformed code preserves the original code's fitness for being verified by commercial validation tools. The processor(s) may be configured to store the transformed source code. The processor(s) may be configured to create an annotation which includes invariants that specify verification properties and/or verification conditions that must hold true for the transformed code if the transformed code conforms to the code specifications. The annotation also includes at least one assumption as a hint that can be used to determine if the verification properties and/or verification conditions hold true. Hints address the problem that validation tools generally proceed by search over potential proof-strategies in order to find one which succeeds. The search-space may be large. Therefore, the hints are added to ensure that information needed to point such searches in a fruitful direction is present among the code annotations. The annotations may be in a form that will not be compiled when the transformed source code is compiled. The processor(s) may be configured to store the annotation in correspondence to the relevant at least one transformed portion of the transformed source code to produce protected code. The correctness of the protected code can be verified by examining the annotation.

Another aspect of the present disclosure relates to a method for producing protected code in which functionality of the protected code can be verified. The method may include receiving computer source code that, when compiled and executed, produces functionality in accordance with code specifications. The method may include applying transformations to at least one portion of the computer source code to produce transformed source code having at least one transformed portion. The method may include storing the transformed source code. The method may include creating an annotation which includes invariants that specify verification properties and/or verification conditions that must hold true for the transformed code if the transformed code conforms to the code specifications. The annotation also includes at least one assumption as a hint that can be used to determine if the verification properties and/or verification conditions hold true. The annotation may be in a form that will not be compiled when the transformed source code is compiled. The method may include storing the annotation in correspondence to the relevant at least one transformed portion of the transformed source code to produce protected code. The correctness of the protected code can be verified by examining the annotation.

Yet another aspect of the present disclosure relates to a non-transient computer-readable storage medium having instructions embodied thereon, the instructions being executable by one or more processors to perform a method for producing protected code in which functionality of the protected code can be verified. The method may include receiving computer source code that, when compiled and executed, produces functionality in accordance with code specifications. The method may include applying transformations to at least one portion of the computer source code to produce transformed source code having at least one transformed portion. The method may include storing the transformed source code. The method may include creating an annotation which includes invariants that specify verification properties and/or verification conditions that must hold true for the transformed code if the transformed code conforms to the code specifications. The annotation also includes at least one assumption as a hint that can be used to determine if the verification properties and/or verification conditions hold true. The annotation may be in a form that will not be compiled when the transformed source code is compiled. The method may include storing the annotation in correspondence to the relevant at least one transformed portion of the transformed source code to produce protected code. The correctness of the protected code can be verified by examining the annotation.

Implementations also include methods and apparatus for testing the protected software code to determine if the verification properties and/or verification conditions hold true based on the assumptions. Generally, the original code to be protected, and annotations present in that original code, are expected to be processed by a transformation tool. However, a user of such a tool will likely not simply trust that the supplier created a completely correct tool. In fact, given the complexity of such a tool and the limitations of human programmers, any such tool is unlikely to be perfect. Implementations solve this problem with a design of a validation tool such that the users of the transformation tool can ensure, to their own satisfaction, that the transformation for any particular program was correctly done, e.g., that the resulting code preserves the semantics of the original code, and preserves the validity of the annotations provided with the original code.

The tool uses commercial verifiers which need not be selected in advance by the supplier of the transformation tool. Users who employ the programs produced by that tool can select the verifiers. A validation tool includes an annotation reading module. The annotations can be fed into the validation tool through a validation controller that serves as in interface to multiple verification tools that may be selected by the user to verify the correctness of the output of the transformation tool. The validation controller can both select and call the verification tools and perform the verification, on the user's own premises for example. The validation controller, of course, can be made entirely open to the inspection of users so that they can see for themselves that the transformation tool supplier will plainly and transparently invokes whatever verification tools the customer chooses.

A validation aggregator polls the verification tools and report s “Valid” only if all verification tools, or a predetermined majority thereof, agree on correctness of the transformations. Therefore, a user can be assured that the transformation tool itself has a correct implementation. The output of the transformation tool need only be trusted at the point where it succeeds in being verified by all, or a predetermined majority of, the verifiers selected by the customer. Where validation fails, it will often be the case that modest changes to the input program can produce an equivalent program from which the transformation tool produces an output program which succeeds in passing the validation process where its predecessor failed.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a computer architecture configured for producing protected code in which functionality of the protected code can be verified, in accordance with one or more implementations.

FIG. 2 illustrates a method for producing protected code in which functionality of the protected code can be verified, in accordance with one or more implementations.

FIG. 3 illustrates a computer architecture in accordance with an implementation in which the validation tools is separate from annotating servers.

### DETAILED DESCRIPTION

As noted above to achieve the highest levels of assurance that transformations to computer software code have substantially maintained correctness of the code, it is desirable to prove that the original version of the code and the transformed version of the code are semantically equivalent. The proof “obligations” (properties which must be proven to achieve correctness) of some simple transformations' may be easy to discharge as they don't invalidate expressed properties about the original and transformed versions of software. As an example, the program snippets below each assert that y>2 which can be easily verified visually to be true with simple mathematic techniques.

Original:
x = 2; y = 5;
y = x + y;
assert(y > 2);
Transformed:
x1 = 1; x2 = 1; y = 5;
y = x1 + y; y = x2 + y;
assert(y > 2);

To obtain the transformed snippet above, a simple obfuscating transformation called “variable splitting”, where the variable x is split into two other variables x1 and x2, has been used. It can be readily seen that the assertion y>2 still holds in the transformed version. However, most transformations, whether optimizations or obfuscations (but particularly obfuscations), invalidate any assertions that hold true about the untransformed version of the software. Obfuscation is especially troublesome when determining semantic equivalence because the goal of obfuscation is to hide the functionality of the code from prying eyes while maintaining the functionality of the untransformed version of the software.

As another example, the original code snippet below is clearly correct with respect to the assertion that is expressed (e.g. z==30) as is evident by simple inspection of the code. However, the transformed code snippet below includes a non-linear opaque predicate transformation that hides the fact that at program's end, the value of z is in fact 30.

```
Original:
int main (int argc, char *argv[])
{
  unsigned int x = 10;
  unsigned int y = 20;
  unsigned int z = 0;
  z = x + y;
  assert(z == 30);
  return 0;
}
Transformed:
int main (int argc, char *argv[])
{
  unsigned int x = 10;
  unsigned int y = 20;
  unsigned int z = 0;
  unsigned int a = ((unsigned int)argc);
  unsigned int w = a * a;
  w = a + w;
  w = w % 2;
  if (w == 0)
  {
  z = x + y;
  }
  else
  {
  z = y - x;
  }
  assert(z == 30);
  return 0;
}
```

The transformation shown above makes it more difficult to determine that the assertion still holds, but if one makes the assumption that x :int, 2% (x*x+x)==0, it can be deduced that the assertion does hold and the value of z is in fact 30. The implementations discussed herein, referred to as “proof-carrying transformations”, provide additional annotations, such as additional assumptions to show that that the transformations maintain certain program properties expressed as specifications.

The transformations can be applied in a conventional manner, as is well known in the art. However, the transformations can be associated with metadata annotations that includes invariants and/or assertions in some formal annotation language, such as ACSL. The invariants will capture properties or conditions that need to hold true for the transformed code as evidence the transformations have not invalidated the specifications of the code. The invariants can be thought of as a sort of key that can undo the transformations to show that the desired behavior (as encoded in the specifications) is still valid. The annotations can be expressed in the form comments (such as surrounded by “/*” and “*/” pairs for C programs) and may be read by a validation tool (described below) that understand such annotations. As such these annotations/comments will not be included in the binaries once the source code is compiled—as is the case for any general comments in the source. “Hints”, in the form of assumptions, can be included in the annotations along with the corresponding invariants. In formal annotation language settings, invariants can be specified using the familiar “assert” facility. For example, in C language programming the “assert( )” function can include any expression of variable that is to be tested within the parentheses. If the variable or expression evaluates to TRUE, assert( ) does nothing. If it evaluates to FALSE, assert( ) displays an error message and aborts program execution. Hints can be expressed using the “assume” facility which sets variable properties and relationships between variables.

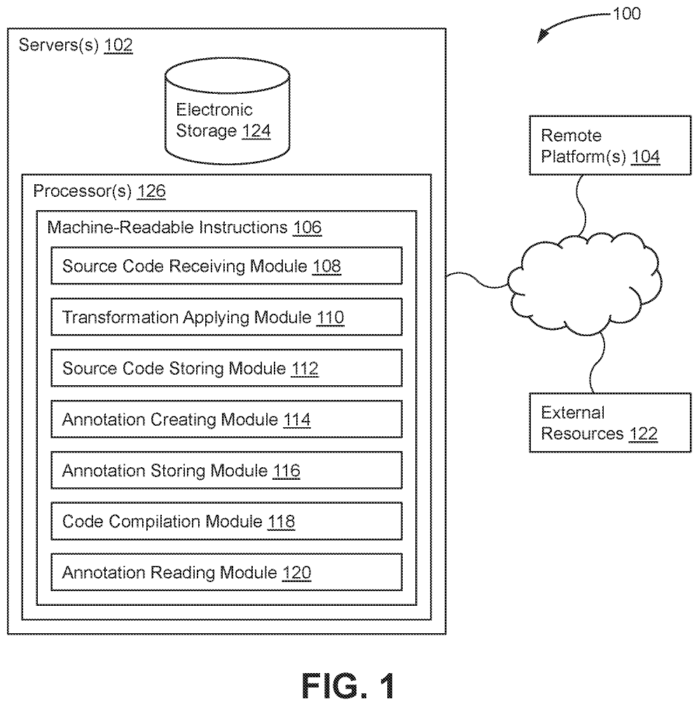

FIG. 1 illustrates a system 100 configured for producing protected code in which functionality of the protected code can be verified, in accordance with one or more implementations. In some implementations, system 100 may include one or more servers 102. Server(s) 102 may be configured to communicate with one or more remote computing platforms 104 according to a client/server architecture and/or other architectures. Remote computing platform(s) 104 may be configured to communicate with other remote computing platforms via server(s) 102 and/or according to a peer-to-peer architecture and/or other architectures. Users may access system 100 via remote computing platform(s) 104. External resources 122 can be computing platforms that store and/or provide information to be used by server(s) 102.

Server(s) 102 may be configured by machine-readable instructions 106. Machine-readable instructions 106 may include one or more instruction modules. The instruction modules may include computer program modules. The instruction modules may include one or more of computer source code receiving module 108, transformation applying module 110, source code storing module 112, annotation creating module 114, annotation storing module 116, code compilation module 118, annotation reading module 120, and/or other instruction modules.

Computer source code receiving module 108 may be configured to receive computer source code that, when compiled and executed, produces functionality in accordance with code specifications. Transformation applying module 110 may be configured to apply transformations to at least one portion of the computer source code to produce transformed source code having at least one transformed portion. The transformations may be optimizations and/or obfuscations. Source code storing module 112 may be configured to store the transformed source code in electronic storage 124, remote platforms 104 and/or external resources 122 shown in FIG. 1. For example, in some implementations, transformations can be accomplished by a different system and, in such cases, system 100 need only receive the transformed code or portions thereon.

As noted above, it is important that the transformations performed by the transformation tool, which transforms the code in the original input program and transforms the annotations in the original program so that the assertions in those annotations still hold, also be verifiable. Software obfuscation tools make use of many kinds of transformations to protect software by making its operation more obscure and hence harder for an attacker to subvert by tampering. Transformations may also make the code more resistant to purposeful tampering by entangling operations in the code so that a small change in the transformed code is likely to cause cascading errors downstream of the change. This results in more secure cod by making any purposeful alteration which an attacker might attempt to make (e.g., to turn off billing or to accept invalid passwords) unlikely to achieve its highly specific purpose.

However effective known techniques of rendering transformations may be, the transformation tool should limit itself to those transformations which can readily be verified. As an example, one popular method of obfuscating code is to employ an obfuscated interpreter with an obscure instruction set to replace the original directly executed machine code with an interpretive code. However, verifying such a transformation is beyond the capabilities of current verification tools. Therefore, such transformations are not desirable to be employed in a transformation tool of the implementations disclosed herein. Another popular technique of obfuscation is to split the execution of a sequential program into multiple parallel communicating threads, the effect of the execution of which implements the original functionality. Again, such a transformation is beyond what can be expected to be verified by commercially available verification tools.

Indeed, even if transformations are limited to those involving no additional threads of control and no interpretive code, more complex transformations can easily exceed the capacities of commercial code verifiers. For this reason, many of the kinds of transformations used in commercial software obfuscators are not optimal in the context of the transformation tool of the disclosed implementations. As will become apparent below, each candidate transformation to be included in such a transformation tool must be verified in general by one, or preferably multiple, known verifiers. Note that the transforms used by the transformation tool must be limited for both the transformed executable code and the transformed annotations. While the difference between these two forms of code is dramatic as far as executable code is concerned, complexity in the executable code presents the verifier with the same problems as complexity of the annotations. Over time, as such verifiers grow in capacity, and as the creators of the transformation tool gain more knowledge of verification strategies, increasing numbers of transformations may be introduced, whether in the executable code or the annotations. However, many transformations popular in current obfuscators do not currently meet the stringent verifiability requirement imposed by a transformation tool of the disclosed implementations.

Annotation creating module 114 may be configured to create an annotation which includes verification properties and/or verification conditions that must hold true for the transformed code if the transformed code conforms to the code specifications. The annotations can also include hints, in the form of assumptions, that help deduce whether the properties and/or conditions hold true in the transformed code. As noted above, when the code is transformed, the assertions which must hold in the code are transformed as well. For example, if the original code contains an assertion that, at a specific point, x==7, and we encode x in the transformed code to x′=f(x) where f is some invertible encoding, then the assertion must be changed to f⁻¹(x′)==7. Similarly, if at a specific point we assert that x<y, and in the transformed program, we replace x by x′=f(x) and y by y′=g(x), with both f and g being invertible encodings, the assertion in the transformed program is that f⁻¹(x′)<g⁻¹(y′). That is, if an assertion holds for the original variable, it should also hold for the decoding (the inverse transformation) of the new variables in the transformed program which encode the information carried by the original variables in the original program. The annotations are metadata that may be in a form that will not be compiled when the transformed source code is compiled. The annotation can be stored in electronic storage 124, remote platforms 104 and/or external resources 122 shown in FIG. 1, for example. The hints described above can be expressed as an ‘assume’ and are used for proving local correctness properties that have otherwise been proven using an earlier ‘assert’. Other kinds of hints may be inserted that are used for efficiency purposes to make the verification process more optimized (e.g. x=3; assume (x==3)) but “hints” should not be used as an “escape hatch” to make the verification process succeed. For example, the combination of assert (x>5) and assume (x>5) should ne be used.

As noted above, in addition to the modification of the assertions according to the encodings for the transformed code, it may be desirable to add hints to aid the SMT solver in proving the validity of the assertions. For example, suppose that f(x) above is 1922910689u*x in, for example, C source code targeted to a 32-bit machine, so that integer operations are modulo 2³²=4294967296u (where the trailing ‘u’ indicates that the number is unsigned). Then the assertion that f^{-1(x′)==}7 becomes the assertion that 3951868449u*x′==7. However, the SMT solver may be unable to determine the validity of this assertion unless we include the hint that 1922910689u*3951868449u=1 mod 2³² (i.e., that the finite-ring inverse of 1922910689u is 3951868449u in the modulus of the target machine word). Such mathematically true, but unapparent, assertions are not likely to be discovered by an SMT solver, so they can be added to the SMT solver's working assertions for the validation of the code to succeed.

The general procedure for the creation of hints to assist the verifiers employed under the control of the validation tool is as follows. By experimentation on transformed code, it is determined what aspects of the code and its annotations can and cannot be verified by various known verifiers. Hints can take two basic forms. One form is the injection of facts which can easily be independently verified, such as the property above that the unsigned numbers above are finite-ring inverses of one another modulo 2³², as assumptions to be used by verifiers. The other form is a reordering or reconfiguring of the code in order to facilitate verification by reducing the number of intermediate proof steps which a verifier must carrying out in order to complete the verification of the code. For example, it is sometimes necessary to repeat common subexpressions within the code, thus depending on the optimizer (which runs only after verification has already succeeded) to avoid reevaluating them, opposed to assigning such common values to variables and then reusing the variables in place of the original expressions. Experimentation with some verifiers indicates that such code repetition can enable verifiers to succeed where they would otherwise fail: including the repetitions puts them on the verifier's immediate proof-search path, whereas placing their values in intermediate variables may incur far longer, and perhaps infeasibly longer, search paths, causing verifiers to fail. Therefore, verification tools can be selected prior to transformation and transformations and annotations can be created in manner such that that the transformations are verifiable by the verification tools.

Annotation storing module 116 may be configured to store the annotation in correspondence to the relevant at least one transformed portion of the transformed source code to produce protected code. Each annotation may be associated with one of multiple transformations and the storing the annotation includes storing each annotation in correspondence with the associated one of multiple transformations. The creating an annotation can include receiving the computer source code, receiving the transformed computer source code and creating at least one verification property and/or verification condition that that may be valid if and only if the protected code preserves the semantic equivalence with respect to the computer source code. The correctness of the protected code can be verified by examining the annotation as described in detail below.

Code compilation module 118 may be configured to compile the protected code in to executable code. Of course, as noted above, code instructions are compiled, and the annotations are not compiled. The protected source code can be stored in one or more of electronic storage 124, remote platforms 104 and/or external resources 122, for example. The annotations, while stored in correspondence to code portions, need not be stored on the same device/memory as the code portions.

Annotation reading module 120 may be configured to read the annotations with one or more verification tools that verify the correctness of the transformations based on the associated annotation to thereby validate the protected code. In some implementations, multiple annotations may be created. In some implementations, the annotations may be expressed in a formal annotation language. Annotation module 120, while shown as part of server(s) 102, can be incorporated in a separate validation tool on a separate device or platform and validation can be accomplished as a process distinct from the other steps.

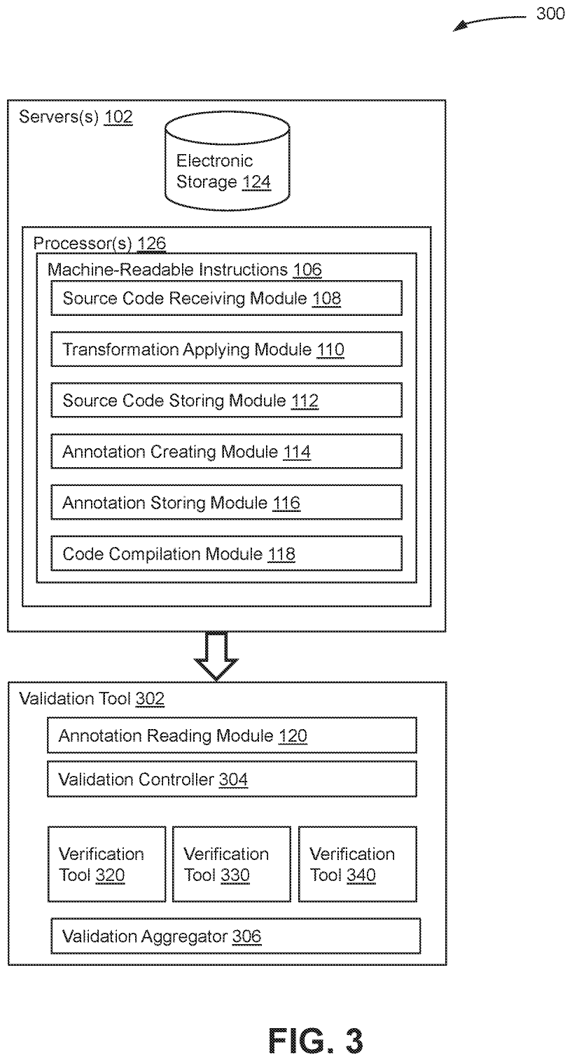

As described in more detail below with respect to FIG. 3, the annotations (such as assertions and any hints) can be fed into the validation tool which can be a relatively simple front-end that will call well-known off-the-shelf verification tools (e.g. frama-c, smack, seahorn, and the like). The validation tool can be configured to report “Valid” only if all off-the-shelf verification tools, or a predetermined majority thereof, agree on correctness of the transformations, i.e. (if all or most tools can discharge the VCs). Otherwise, the validation tool” will report “Not Valid”. This set-up ensures detection and prevention of errors which is the basis for high assurance that the transformations maintain input program properties and do not invalidate them. Note that the implementations place trust in the validation tool instead of the transformation tool. This reduces Trusted Computing Base (TCB) of the system to the validation tool which can be a small front-end that delegates the task of verification to off-the-shelf verification tools. The small front-end itself can be verified by the usual means (code reviews, blackbox and whitebox testing, etc). Thus the use of annotations, in the manner disclosed herein allows a computer validation system to operate more efficiently by reducing computing resources required to validate secured code and thus allows a computing system to validate code faster and/or with fewer computing resources.

Confidence or trust in the validation tool may be increased by increasing the number of verification tools. This is in contrast to the more traditional methods of ensuring code correctness such as in the CompCert compiler where the whole compiler is “certified” to produce code that maintains the semantics of the input code. Translation validation validates semantic equivalence of ‘properties of interest’ between the source and the target of a compiler or a code generator. A translation validation tool, such as that disclosed herein, receives as input both the original code and transformed code and determines at least one verification condition that is valid iff (if and only if) the generated code faithfully preserves the properties of interest such as semantic equivalence. Translation validation is applied per translation, as opposed to the alternative of validating the code generator or compiler. In general, validating the compiler is an order of magnitude more expensive than validating each translation instance. Another advantage of translation validation is that there is less dependence on changes to the compiler/code generator. In conventional systems, such changes typically invalidate any established correctness proofs.

In some implementations, server(s) 102, client computing platform(s) 104, and/or external resources 122 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 122 may be operatively linked via some other communication media.

A given remote computing platform 104 may include one or more processors configured to execute computer program modules. The computer program modules may be configured to enable an expert or user associated with the given client computing platform 104 to interface with system 100 and/or external resources 122, and/or provide other functionality attributed herein to remote computing platform(s) 104. By way of non-limiting example, the given remote computing platform 104 may include one or more of a desktop computer, a laptop computer, a handheld computer, a tablet computing platform, a Smartphone, a gaming console, and/or other computing platforms.

External resources 122 may include sources of information outside of system 100, external entities participating with system 100, and/or other resources. In some implementations, some or all of the functionality attributed herein to external resources 122 may be provided by resources included in system 100.

Server(s) 102 may include electronic storage 124, one or more processors 126, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 124 may comprise non-transitory storage media that electronically stores information. The electronic storage media of electronic storage 124 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 124 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 124 may include one or more virtual storage resources (e.g., cloud storage, a virtual private network, and/or other virtual storage resources). Electronic storage 124 may store software algorithms, information determined by processor(s) 126, information received from server(s) 102, information received from client computing platform(s) 104, and/or other information that enables server(s) 102 to function as described herein.

Processor(s) 126 may be configured to provide information processing capabilities in server(s) 102. As such, processor(s) 126 may include one or more of a digital processor, an analog processor, a digital circuit designed to process information, an analog circuit designed to process information, a state machine, and/or other mechanisms for electronically processing information. Although processor(s) 126 is shown in FIG. 1 as a single entity, this is for illustrative purposes only. In some implementations, processor(s) 126 may include a plurality of processing units. These processing units may be physically located within the same device, or processor(s) 126 may represent processing functionality of a plurality of devices operating in coordination. Processor(s) 126 may be configured to execute modules 108, 110, 112, 114, 116, 118, and/or 120, and/or other modules. Processor(s) 126 may be configured to execute modules 108, 110, 112, 114, 116, 118, and/or 120, and/or other modules by software; hardware; firmware; some combination of software, hardware, and/or firmware; and/or other mechanisms for configuring processing capabilities on processor(s) 126. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, and/or 120 are illustrated in FIG. 1 as being implemented within a single processing unit, in implementations in which processor(s) 126 includes multiple processing units, one or more of modules 108, 110, 112, 114, 116, 118, and/or 120 may be implemented remotely from the other modules. The description of the functionality provided by the different modules 108, 110, 112, 114, 116, 118, and/or 120 described below is for illustrative purposes, and is not intended to be limiting, as any of modules 108, 110, 112, 114, 116, 118, and/or 120 may provide more or less functionality than is described. For example, one or more of modules 108, 110, 112, 114, 116, 118, and/or 120 may be eliminated, and some or all of its functionality may be provided by other ones of modules 108, 110, 112, 114, 116, 118, and/or 120. As another example, processor(s) 126 may be configured to execute one or more additional modules that may perform some or all of the functionality attributed below to one of modules 108, 110, 112, 114, 116, 118, and/or 120.

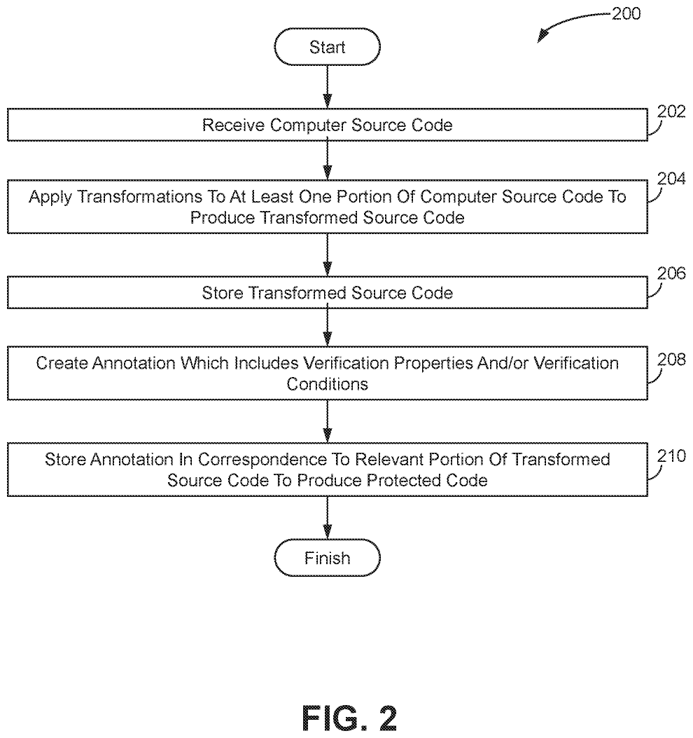

FIG. 2 illustrates a method 200 for producing protected code in which functionality of the protected code can be verified, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices, such as system 100 of FIG. 1 (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving computer source code that, when compiled and executed, produces functionality in accordance with code specifications. Operation 202 may be performed by one or more hardware processors configured by machine-readable instructions including a module that is the same as or similar to computer source code receiving module 108, in accordance with one or more implementations.

An operation 204 may include applying transformations to at least one portion of the computer source code to produce transformed source code having at least one transformed portion. Operation 204 may be performed by one or more hardware processors configured by machine-readable instructions including a module that is the same as or similar to transformation applying module 110, in accordance with one or more implementations.

An operation 206 may include storing the transformed source code. Operation 206 may be performed by one or more hardware processors configured by machine-readable instructions including a module that is the same as or similar to source code storing module 112, in accordance with one or more implementations.

An operation 208 may include creating an annotation which includes verification properties and/or verification conditions that must hold true for the transformed code if the transformed code conforms to the code specifications. The annotation may also include hints as described above. The annotation may be in a form that will not be compiled when the transformed source code is compiled. Operation 208 may be performed by one or more hardware processors configured by machine-readable instructions including a module that is the same as or similar to annotation creating module 114, in accordance with one or more implementations.

An operation 210 may include storing the annotation in correspondence to the relevant at least one transformed portion of the transformed source code to produce protected code. The correctness of the protected code can be verified by examining the annotation. Operation 210 may be performed by one or more hardware processors configured by machine-readable instructions including a module that is the same as or similar to annotation storing module 116, in accordance with one or more implementations.

FIG. 3 illustrates an architecture 300 in which the validation tool is separate from portions of the system that create the transformed code. As shown in FIG. 3, validation tool 302 includes annotation reading module 120 in a system that is separate from Server(s) 102. Otherwise server(s) 102 operate as described in FIG. 1. However, in other implementations, validation tool 302 can be integrated into Server(s) 102. The annotations (assertions and any hints) are fed into the validation tool 302 includes annotation reading module 120 (described above with respect to FIG. 1) and validation controller 304. Validation controller serves as in interface to multiple verification tools 320, 330, and 340. As noted above, the verification tools can be off-the-shelf verification tools (e.g. frama-c, smack, seahorn, and the like). Although most verification tools employ an annotation language that is based on the familiar assert, assume, pre-conditions and post-conditions, the actual syntax and semantics of each language can be different from the others. This implies that the additional annotations will be tool specific and also that the correct version of the annotations must be emitted for each tool. Implementations can use a simple intermediate annotation language (SIAL) which a translator backend will translate to the specific annotation language (such as Why3, Boogie and other intermediate verification languages. Validation controller 304 will call identify and call verification tools 320, 330 and 340, and send the annotations and any other required information to the verification tools in the proper format and syntax. Validation controller 304, depending on the list of available verification tools, calls the ‘SIAL backend’ which for each available tool, generates the tool specific instance of the ‘Protected code+assertions/hints’. Validation controller 304 then calls each corresponding tool with appropriate options on the protected code instance.

Validation aggregator 306 can include a simple script that gathers exist status from each called tool. Validation aggregator 306 can be configured by default to implement a conjunction (‘AND’) on all exist codes, then output ‘VALID’ otherwise output ‘INVALID’. In case the result is ‘INVALID’ errors from each failing tool will be reported. Put more simply, validation aggregator 306 polls the verification tools and reports “Valid” only if all verification tools, or a predetermined majority thereof, agree on correctness of the transformations. Otherwise, the validation tool 302 will report “Not Valid”. This set-up ensures detection and prevention of errors which is the basis for high assurance that the transformations maintain input program properties and thus that the original code and the transformed code have sematic equivalence.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for producing protected code in which functionality of the protected code can be verified, the system comprising:
one or more hardware processors configured by machine-readable instructions to:
receive transformed source code, the transformed source code being created from original source code and including at least one transformed portion of code which obfuscates at least one of the code logic and the code flow and at least one transformed annotation corresponding to the transformed portion, the transformed source code, when compiled and executed, produces functionality that is semantically equivalent to functionality of the original source code in accordance with code specifications;
store the transformed source code;
create at least one additional annotation which includes invariants that specify verification properties and/or verification conditions that must hold true for the transformed source code if the transformed source code conforms to the code specifications, the at least one annotation also including assumptions as hints for determining whether the verification properties and/or verification conditions hold true for the transformed source code, the at least one annotation being in a form that will not be compiled when the transformed source code is compiled;
store the at least one additional annotation in correspondence to each of the at least one transformed portion of the transformed source code to produce protected code, wherein the correctness of the protected code can be verified by examining the at least one annotation.

2. The system of claim 1, wherein multiple additional annotations are created, each additional annotation being associated with one of the at least one transformed portion and the storing the at least one additional annotation includes storing each additional annotation of the multiple annotations in correspondence with the associated one of the at least one transformed portion.

3. The system of claim 2, wherein the additional annotations are expressed in a formal annotation language.

4. (canceled)

5. The system of claim 2, wherein the one or more hardware processors are further configured by machine-readable instructions to:
compile instructions of the protected code into executable code;
read the additional annotations with one or more verification tools that verify the correctness of the at least one transformed portion based on the associated additional annotation to thereby validate the protected code.

6. The system of claim 1, wherein creating the at least one additional annotation comprises receiving the original source code, receiving the transformed source code and creating at least one verification property and/or verification condition that that is valid if and only if the protected code preserves the semantic equivalence with respect to the original source code.

7. The system of claim 1, wherein receiving the transformed source code comprises receiving the original source code and applying transformations to the at least one portion of the original source code to produce the transformed source code.

8. A method of producing protected code in which functionality of the protected code can be verified, the method comprising:
receiving transformed source code, the transformed source code being created from original source code and including at least one transformed portion of code which obfuscates at least one of the code logic and the code flow and at least one transformed annotation corresponding to the transformed portion, the transformed source code corresponding to original source code that, when compiled and executed, produces functionality that is semantically equivalent to functionality of the original source code in accordance with code specifications;
storing the transformed source code;
creating at least one additional annotation which includes invariants that specify verification properties and/or verification conditions that must hold true for the transformed source code if the transformed source code conforms to the code specifications, the at least one annotation also including assumptions as hints for determining whether the verification properties and/or verification conditions hold true for the transformed source code, the at least one annotation being in a form that will not be compiled when the transformed source code is compiled;
storing the at least one additional annotation in correspondence to each of the at least one transformed portion of the transformed source code to produce protected code, wherein the correctness of the protected code can be verified by examining the annotation.

9. The method of claim 8 wherein multiple additional annotations are created, each additional annotation being associated with one of the at least one transformed portion and the storing the at least one additional annotation includes storing each additional annotation of the multiple additional annotations in correspondence with the associated one of the at least one transformed portion.

10. The method of claim 9, wherein the additional annotations are expressed in a formal annotation language.

11. (canceled)

12. The method of claim 9, further comprising:
compiling instructions of the protected code into executable code; and
reading the additional annotations with one or more verification tools that verify the correctness of the at least one transformed portion based on the associated additional annotation to thereby validate the protected code.

13. The method of claim 8, wherein creating the at least one additional annotation comprised receiving the original source code, receiving the transformed source code and creating at least one verification property and/or verification condition that is valid if and only if the protected code preserves the semantic equivalence with respect to the original source code.

14. The method of claim 8 wherein receiving the transformed source code comprises receiving the original source code and applying transformations to the at least one portion of the original source code to produce the transformed source code.

15. A non transitory computer-readable storage medium having instructions embodied thereon, the instructions being executable by one or more processors to perform a method for producing protected code in which functionality of the protected code can be verified, the method comprising:
receiving transformed source code, the transformed source code being created from original source code and including at least one transformed portion of code which obfuscates at least one of the code logic and the code flow and at least one transformed annotation corresponding to the transformed portion, the transformed source code, when compiled and executed, produces functionality that is semantically equivalent to functionality of the original source code in accordance with code specifications;
storing the transformed source code;
creating at least one additional annotation which includes invariants that specify verification properties and/or verification conditions that must hold true for the transformed source code if the transformed source code conforms to the code specifications, the at least one annotation also including assumptions as hints for determining whether the verification properties and/or verification conditions hold true for the transformed source code, the at least one annotation being in a form that will not be compiled when the transformed source code is compiled;
storing the at least one additional annotation in correspondence to each of the at least one transformed portion of the transformed source code to produce protected code, wherein the correctness of the protected code can be verified by examining the annotation.

16. The computer-readable storage medium of claim 15, wherein multiple additional annotations are created, each additional annotation being associated with one of the at least one transformed portion and the storing the at least one additional annotation includes storing each additional annotation of the multiple additional annotations in correspondence with the associated one of the at least one transformed portion.

17. The computer-readable storage medium of claim 16, wherein the additional annotations are expressed in a formal annotation language.

18. (canceled)

19. The computer-readable storage medium of claim 16, wherein the method further comprises:
compiling instructions of the protected code into executable code; and
reading the additional annotations with one or more verification tools that verify the correctness of the at least one transformation based on the associated annotation to thereby validate the protected code.

20. The computer-readable storage medium of claim 15, wherein the creating the at least one additional annotation comprises receiving the original source code, receiving the transformed source code and creating at least one verification property and/or verification condition that that is valid if and only if the protected code preserves the semantic equivalence with respect to the original source code.

21. The computer-readable storage medium of claim 15, wherein receiving the transformed source code comprises receiving the original source code and applying transformations to the at least one portion of the original source code to produce the transformed source code.

22. A computer system configured for verifying protected code, the system comprising:
one or more computer hardware processors configured by machine-readable instructions to:
receive original source code, including executable code and annotations, that the original source code, when compiled and executed, produces functionality in accordance with code specifications;
receive transformed source code, the transformed source code being created from original source code and including at least one transformed portion of code which obfuscates at least one of the code logic and the code flow and at least one corresponding transformed annotation corresponding to the transformed portion, the transformed source code when compiled and executed, produces functionality that is semantically equivalent to functionality of the original source code in accordance with code specifications;
receive at least one additional annotation which includes invariants that specify verification properties and/or verification conditions that must hold true for the transformed source code if the transformed source code conforms to the code specifications, the at least on additional annotation also including assumptions as hints for determining whether the verification properties and/or verification conditions hold true for the transformed source code, and being in a form that will not be compiled when the transformed source code is compiled; and
verifying the correctness of the protected code by examining the at least one additional annotation.

23. The system of claim 22, wherein verifying the correctness of the protected code is accomplished by a validation tool that comprises a validation controller, multiple verification tools and a validation aggregator, wherein the validation controller is configured to generate a tool -specific instance of the additional assertions for each verification tool and call each verification tool with appropriate options, and wherein the validation aggregator is configured to gather exist status codes from each verification tool and implement an AND on the exist codes and output ‘VALID’ when all verification tools indicate verification.

24. The system of claim 23, wherein the verification tools are selected prior to creation of the annotations and the transformations and annotations are created in a manner such that the transformations can be verified by the verification tools.

25. A computer system configured for verifying protected code, the system comprising:
one or more computer hardware processors configured by machine-readable instructions to:
receive original source code, including executable code and annotations, that the original source code, when compiled and executed, produces functionality in accordance with code specifications;
receive transformed source code , the transformed source code being created from original source code and including at least one transformed portion of code which obfuscates at least one of the code logic and the code flow and at least one transformed annotation corresponding to the transformed portion, the transformed source code when compiled and executed, produces functionality that is semantically equivalent to functionality of the original source code in accordance with code specifications;
receive at least one additional annotation which includes invariants that specify verification properties and/or verification conditions that must hold true for the transformed source code if the transformed source code conforms to the code specifications, the at least on additional annotation also including assumptions as hints for determining whether the verification properties and/or verification conditions hold true for the transformed source code, and being in a form that will not be compiled when the transformed source code is compiled;
verifying the correctness of the protected code by examining the at least one additional annotation, wherein the verifying the correctness of the protected code is accomplished by a validation tool that comprises a validation controller, multiple verification tools and a validation aggregator, wherein the validation controller is configured to generate a tool -specific instance of the additional assertions for each verification tool and call each verification tool with appropriate options, and wherein the validation aggregator is configured to gathers exist status from each verification tool and implement an AND on all exist codes and output ‘VALID’ when all verification tools indicate verification.

26. The system of claim 25, wherein the verification tools are selected prior to creation of the annotations and the transformations and annotations are created in a manner such that the transformations can be verified by the verification tools.
